(19) United States
(12) Patent Application Publication
(10) Pub. No.: US 2002/0070607 A1
(43) Pub. Date: Jun. 13, 2002

(54) Endless drive track system with guiding brace and method

(76) Inventor: John W. Edwards, Sarasota, FL (US)

Correspondence Address: OLIFF & BERRIDGE, PLC, P.O. BOX 19928, ALEXANDRIA, VA, 22320, US

(21) Appl. No.: 09/731,920

(22) Filed: Dec. 8, 2000

(51) Int. Cl. B62D 55/24

(52) U.S. Cl. 305/165; 305/177

(57) ABSTRACT

An endless drive track system for use with a tracked vehicle includes a planetary drive system having drive rollers, a plurality of roller wheels, an endless track having an interior surface and a plurality of drive lugs attached to the interior surface. Each drive lug includes at least one drive face that is positively engaged by the drive rollers of the planetary drive system, and first and second longitudinal faces. A guiding brace is provided adjacent at least one of the associated first and second longitudinal faces of at least one of the drive lugs. The guiding brace promotes lateral guidance of the endless track and reduces the potential of damaging contact between the longitudinal faces and the roller wheels. The endless track may also include a reinforcing brace having flanges that further protect the longitudinal faces.

### BACKGROUND OF THE INVENTION

1. Field of Invention

The present invention relates to an endless track for an endless drive track system. More particularly, the present invention relates to an endless track having guiding braces for use with a tracked vehicle such as a tractor, bulldozer or tank.

2. Description of Related Art

Conventional endless drive track systems are used with tracked vehicles such as tractors, bulldozers, tanks or the like, as shown in U.S. Pat. No. Re. 33,324, which is incorporated herein by reference in its entirety. As shown in FIG. 1, a vehicle 1 includes an endless drive track system 2 with an endless track 3, a drive system, e.g., a planetary drive system 4, and a plurality of roller wheels 5, also commonly known as idler wheels, that guide, laterally align and support the track 3. The planetary drive system 4 and the plurality of roller wheels 5 are located at separate positions within the endless drive track system 2. For example, when the drive rollers 6 (see FIGS. 2 and 3) of the planetary drive system 4 rotate in a clockwise direction, the endless track 3 is driven in the clockwise direction. The roller wheels 5 also rotate in the clockwise direction due to the frictional engagement of the roller wheels 5 with the driven endless track 3. Alternatively, the roller wheels 5 can be positively driven. Consequently, the drive rollers 6, the roller wheels 5 and the endless track 3 rotate in a common direction.

The endless track 3 is comprised of a plurality of drive sections 7. FIG. 2 shows an exploded perspective view of an exemplary drive section 7 where the drive rollers 6 of the planetary drive system 4 engage the drive section 7 of the endless track. Each drive section 7 includes an interior surface 8 and an exterior surface 9. The exterior surface 9 of each drive section 7 faces away relative to the endless drive track system 2 and includes a tread that contacts the ground over which the tracked vehicle 1 travels. The interior surface 8 of each drive section 7 faces toward the endless drive track system 2 and includes a plurality of drive lugs 10 extending inwardly from the interior surface 8.

Typically, each drive lug 10 includes four faces 10a-10d. Faces 10b and 10d are drive faces that extend in a direction transverse to the traveling direction of the endless track 3 and are contacted and driven by the drive rollers 6. An arrow A indicates the traveling direction of the endless track 3 as being from right to left, although the traveling direction of the endless track 3 can also be from left to right. The remaining faces 10a and 10c are longitudinal faces and extend in a direction substantially parallel to the traveling direction of the endless track 3. At least one purpose of the longitudinal faces 10a and 10c is to guide the endless track 3 as it travels past the roller wheels 5.

FIG. 3 shows a schematic diagram of the drive rollers 6 rotated in a clockwise direction by the planetary drive system 4 to engage and drive the drive lugs 10. When a drive section 7 of the endless track 3 reaches the planetary drive system 4, the rotated drive rollers 6 of the planetary drive system 4 contact drive face lob of the drive lugs 10 to drive the endless track 3 in the clockwise direction. Similarly, when the drive rollers 6 are rotated in the counterclockwise direction, the drive rollers 6 contact drive face 10d of the drive lugs 10 to drive the endless track 3 in a counterclockwise direction. As such, upon contacting the drive face 10b or 10d of the drive lugs 10, the drive rollers 6 are able to drive the drive section 7 of the endless track 3 in the desired traveling direction. The drive rollers 6 repeat the above-described operation for every drive lug 10 passing through the planetary drive system 4.

As the drive rollers 6 of the planetary drive system 4 are typically constructed from wear-resistant materials, e.g., metals, and the endless track 3 is typically made of a polymeric material, the engagement of the drive rollers 6 with the drive lugs 10 of the endless track 3 may result in the wearing down or erosion of the drive lugs 10. Although the drive rollers 6 are illustrated as substantially filling the region between adjacent drive lugs 10, the size of the drive rollers 6 can be made smaller, as long as the drive rollers 6 are capable of engaging the drive faces 10b and 10d of the drive lugs 10.

FIG. 4 shows an exploded perspective view where the roller wheels 5 engage a drive 7 section of the endless track 3 driven in the clockwise, i.e., right to left, direction. In the illustration, three roller wheels 5 are provided on a common shaft, although more or less than three rollers can be provided, and independent shafts may be desirable, depending on need. As such, because of the frictional engagement of the endless track 3 with the roller wheels 5, each roller wheel 5 is rotated in the clockwise direction with the drive section 7 of the endless track 3. The rotation of the roller wheels 5 provides even support across the endless track 3 in an orthogonal direction relative to the direction the track 3 is driven.

FIG. 5 is cross-sectional view of the roller wheels 5 engaging the drive section 7 of the endless track 3 shown in FIG. 4, as taken along section line V-V. The spacing of the roller wheels 5 relative to the drive lugs 10 is such that the roller wheels 5 should not contact the longitudinal faces 10a and 10c of the drive lugs 10 while engaging the drive section 7. To this end, the total length of the combined distances X and y is typically about ⅜″-½″.

As represented by the bi-directional arrows in FIG. 5, the endless track 3 has a tendency to move with respect to the roller wheels 5 in the direction parallel to the axes of the roller wheels 5. Consequently, the roller wheels 5 may contact the longitudinal faces 10a and 10c of the drive lugs 10. As the roller wheels 5 are typically constructed from wear-resistant materials and the endless track 3 is typically made of a polymeric material, the frictional engagement of the roller wheels 5 with the drive lugs 10 results in the wearing down or eroding of the longitudinal faces 10a and 10c of the drive lug 10.

For example, as shown in FIG. 6, which is an enlargement of the dashed box of FIG. 5, contact between the roller wheels 5 and the longitudinal faces 10a and 10c of the drive lug 10 results in the wearing away of the longitudinal faces 10a and 10c. The worn away portions of the drive lug 10 are represented by the shaded region R. The gradual decrease in the surface area weakens the drive lugs 10 and causes early failure of the endless track 3. For example, the endless track 3 may need to be replaced after 300 working hours due to erosion of the drive lugs. Also, due to the reduced surface area, “slipping” can occur between the drive rollers 6 of the planetary drive system 4 and the endless track 3.

Furthermore, the wearing away of the longitudinal faces 10a and 10c weakens the structural integrity of the endless track 3 and permits an increase in lateral “play”, i.e., the extent the endless track 3 moves in the direction parallel to the axes of the roller wheels 5. Also, the wearing away of the endless track 3 frequently requires that the endless track 3 be replaced, which requires a stoppage of work, increases the cost associated with using the tracked vehicle 1, and increases labor costs.

### SUMMARY OF THE INVENTION

One aspect of the invention is to provide an endless track including drive lugs having guiding braces for better lateral alignment of the endless track and to help prevent unwanted lateral play of the endless track. The guiding braces can also provide better resistance against erosion and/or abrasion of the drive lugs.

A further aspect of the invention is to provide an endless drive track system including an endless drive track having a plurality of drive lugs with guiding braces that reduce misalignment of the roller wheels so that axes of the roller wheels are maintained substantially perpendicular to the direction the endless track is driven.

A further aspect of the invention is to provide an endless track that can be retrofitted into existing positive drive track systems using a conventional planetary drive system.

Another aspect of the invention is to provide an endless track having reinforcing braces that are capable of better guiding roller wheels and/or preventing roller wheels from wearing away the longitudinal faces of drive lugs extending from the endless track.

It is another aspect of the invention to provide an endless track having reinforcing braces that reduce any tendency of the drive rollers of the planetary drive system to slip when attempting to engage the drive lugs.

It is another aspect of the invention to provide an endless track having reinforcing braces and/or guiding braces that decrease the frequency with which the endless track must be replaced because the track is worn away, the number of work stoppages to replace the track, as well as labor costs.

In order to achieve the above, and to overcome the shortcomings in the related art, an endless track according to various exemplary embodiments of the invention includes an interior surface, a plurality of drive lugs attached to the interior surface, each of the drive lugs including a first longitudinal face, a second longitudinal face and at least one drive face, and a guiding brace provided adjacent at least one of the first and second longitudinal faces. The guiding brace extends beyond the at least one of the first and second longitudinal faces in a direction toward a longitudinally adjacent drive lug.

In various exemplary embodiments, the endless track includes a first guiding brace and a second guiding brace. The first and second guiding braces may be disposed adjacent the first and second longitudinal faces, respectively, of the at least one of the drive lugs with the first guiding brace extending beyond the first longitudinal face in a first direction toward a longitudinally adjacent drive lug and the second guiding brace extending beyond the second longitudinal face in a second direction toward the longitudinally adjacent drive lug. The second direction may be substantially opposite the first direction or substantially the same as the first direction.

Alternatively or additionally, the first guiding brace may be adjacent at least one of the first and second longitudinal faces of the at least one of the drive lugs, and the second guiding brace may be adjacent at least one of the first and second longitudinal faces of a transversely adjacent drive lug. The first guiding brace extends beyond the at least one of the first and second longitudinal faces of the at least one of the drive lugs in a first direction toward a first longitudinally adjacent drive lug. The second guiding brace extends beyond the at least one of the first and second longitudinal faces of the transversely adjacent drive lug in a second direction toward a second longitudinally adjacent drive lug. The second direction may be substantially opposite the first direction or substantially the same as the first direction.

In various exemplary embodiments, the guiding brace is at least partially embedded in the endless track. In various other exemplary embodiments, the guiding brace is attached to the at least one of the first and second longitudinal faces with at least one of a fastener and an adhesive.

In various exemplary embodiments, the guiding brace extends beyond the at least one of the first and second longitudinal faces of the drive lug in a direction away from the interior surface of the endless track. In various exemplary embodiments, the guiding brace extends beyond the at least one of the first and second longitudinal faces of the drive lug in directions towards a longitudinally adjacent drive lug and away from the interior surface of the endless track.

In various exemplary embodiments of the invention, a guiding brace is provided adjacent one of the first and second longitudinal faces of each drive lug. Further, a reinforcing brace is embedded in the endless track adjacent the other of the first and second longitudinal faces of each drive lug.

In various exemplary embodiments, the reinforcing brace comprises a flange. The flange may be configured to the shape or contour of the other of the first and second longitudinal faces.

In various exemplary embodiments of the invention, the guiding and reinforcing braces may include a connecting section that connects the guiding braces or the guiding brace and the reinforcing brace of each drive lug. In various exemplary embodiments, the connecting section is embedded in the endless track. In various exemplary embodiments, the connecting section spans at least two transversely adjacent drive lugs. Thus, the connecting section may connect the guiding braces of two transversely adjacent drive lugs.

In various exemplary embodiments, the connecting section includes at least one aperture that is configured to interact with a portion of the endless track. The at least one aperture may promote positive locking of the guiding and reinforcing braces with the endless track. The aperture may also receive a bolt or other suitable fastening device for attachment to the endless track and/or a removable tread element.

In various exemplary embodiments, the connecting section includes a rib that extends away from the connecting section in a direction opposite to the guiding braces. The rib may be located on a bottom face of the connecting section at a position spanning at least a region that is between at least two transversely adjacent drive lugs. The rib may provide the connecting section with additional strength to guard against breakage when the endless track drives over an obstruction, such as a rock.

In various exemplary embodiments of the invention, the guiding and/or reinforcing braces may include a support rod extending therebetween through the drive lug. If a connecting section is included, the support rod extends substantially parallel to the connecting section.

In various exemplary embodiments of the invention, the guiding and/or reinforcing braces for each drive lug may include a cap that extends over a top surface of the drive lug.

In various exemplary embodiments of the invention, a section of an exterior surface of the endless track includes a cutout from between adjacent treads. The cutout section of the exterior surface of the endless track reduces the manufacturing and material costs of the endless track and may provide the endless track with additional space to channel any fluids through treads in the track to provide better traction.

Various other exemplary embodiments of the invention provide an endless drive track system including a drive system, an endless drive track having a plurality of drive lugs, each of the drive lugs including at least one drive face that cooperates with the drive system and inside and outside longitudinal faces. A guiding brace is provided adjacent at least one of the inside and outside longitudinal faces. The guiding brace extends beyond the at least one of the inside and outside longitudinal faces in a direction toward a longitudinally adjacent drive lug.

In various exemplary embodiments, the guiding brace extends beyond the at least one of the inside and outside longitudinal faces of the drive lug in a direction away from an interior surface of the endless track. In various exemplary embodiments, the guiding brace extends beyond the at least one of the inside and outside longitudinal faces of the drive lug in directions towards a longitudinally adjacent drive lug and away from the interior surface of the endless track.

The endless drive track system may further comprise a plurality of roller wheels that guide and support the endless track. The guiding brace cooperates with the plurality of roller wheels to guide the endless drive track.

These and other aspects will be described in or apparent from the following detailed description of exemplary embodiments.

### BRIEF DESCRIPTION OF THE DRAWINGS

Various exemplary embodiments of the invention will be described in conjunction with the following drawings in which like reference numerals designate like elements and wherein:

FIG. 1 is a schematic side view of a tracked vehicle having a related endless drive track system;

FIG. 2 is an exploded perspective view of an exemplary drive section where drive rollers of the planetary drive system engage a drive section of the endless track;

FIG. 3 is a schematic diagram of the drive rollers engaging drive faces of the drive lugs of a related drive track system;

FIG. 4 is an exploded perspective view where the roller wheels of the related endless drive track system engage a drive section of the endless track;

FIG. 5 is a cross-sectional view of the roller wheels engaging a drive section of the endless track, as taken along section line V-V of FIG. 4;

FIG. 6 is an enlarged view of the dashed box of FIG. 5 to illustrate the worn regions of the longitudinal faces of the drive lugs due to frictional contact with the roller wheels;

FIG. 7 is a cross-sectional view of an endless track according to a first exemplary embodiment of the invention;

FIG. 8 is a cross-sectional view of an endless track according to a second exemplary embodiment of the invention;

FIG. 9 is a cross-sectional view of an endless track according to a third exemplary embodiment of the invention;

FIG. 10 is a cross-sectional view of an endless track according to the first exemplary embodiment shown in FIG. 7, as taken along section line VII-VII, having an exemplary embodiment of the guiding brace of the invention;

FIG. 11 is a cross-sectional view of an endless track according to a fourth exemplary embodiment of the invention;

FIG. 12 is a cross-sectional view of an endless track according to a fifth exemplary embodiment of the invention;

FIG. 13 is a cross-sectional view of an endless track according to a sixth exemplary embodiment of the invention;

FIG. 14 is a cross-sectional view of an endless track according to a seventh exemplary embodiment of the invention;

FIG. 15 is a cross-sectional view of an endless track according to a eighth exemplary embodiment of the invention;

FIG. 16 is a partial cross-sectional view of an endless track according to a ninth exemplary embodiment of the invention;

FIG. 17 is a partial cross-sectional view of an endless track according to a tenth exemplary embodiment of the invention;

FIG. 18 is a plan view of an exemplary embodiment of an exterior surface of the endless track according to the invention;

FIG. 19 is a cross-sectional view, as taken along section line XIX-XIX of FIG. 20; and

FIG. 20 is a partially sectioned elevation view of a master link joint assembly used to interconnect one or more sections to form an endless track according to the invention.

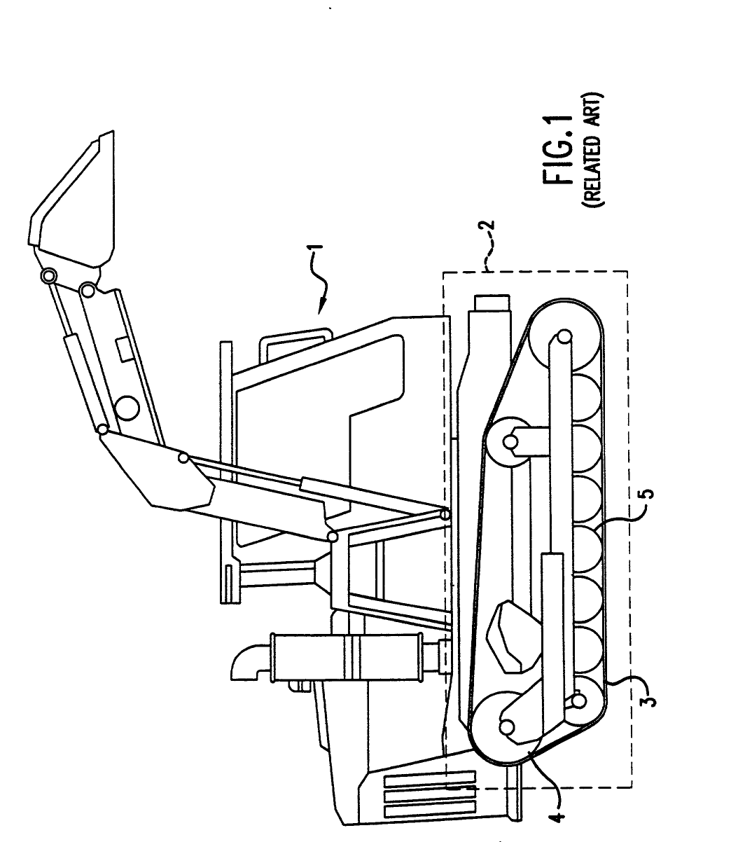

### DETAILED DESCRIPTION OF EXEMPLARY EMBODIMENTS

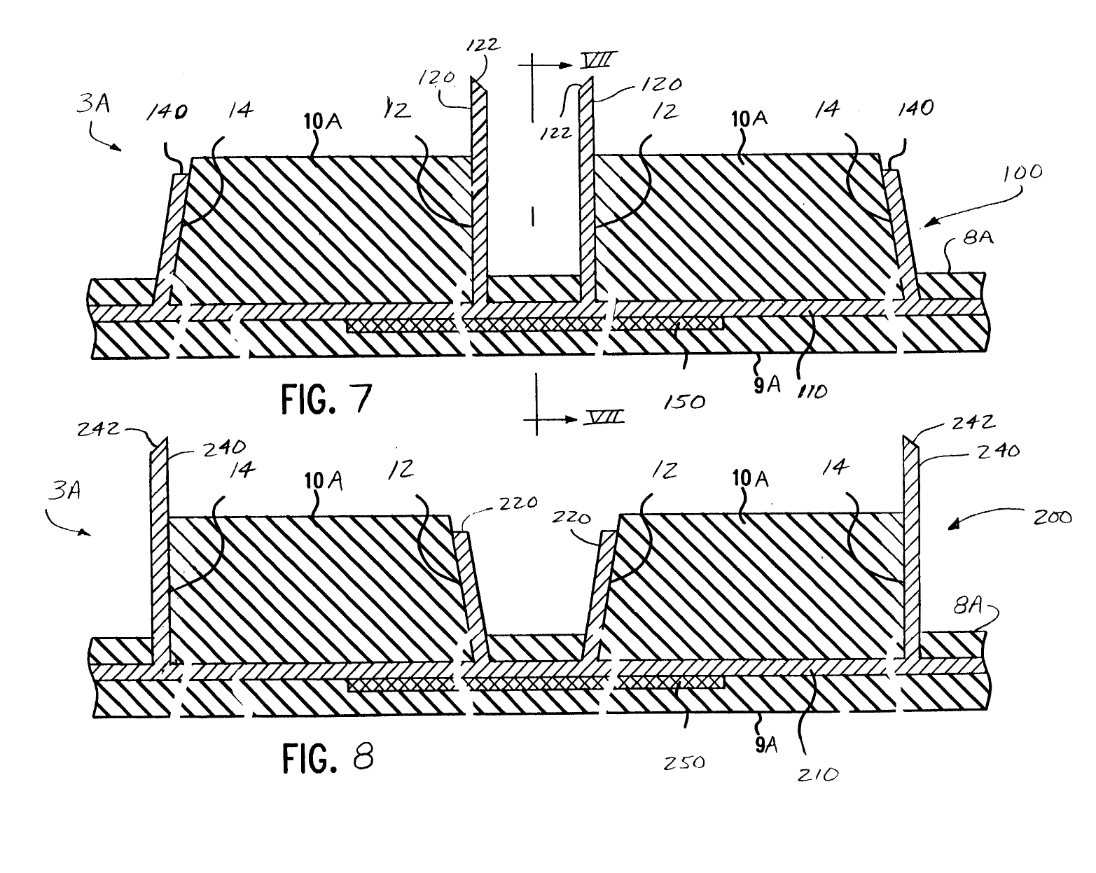

FIG. 7 is a cross-sectional view of an endless track 3A according to a first exemplary embodiment of the invention. The endless track 3A includes a pair of drive lugs 10A that are integrally formed with or attached to an interior surface 8A of the endless track 3A. A plurality of roller wheels 5 (not shown) may be disposed between the pair of drive lugs 10A.

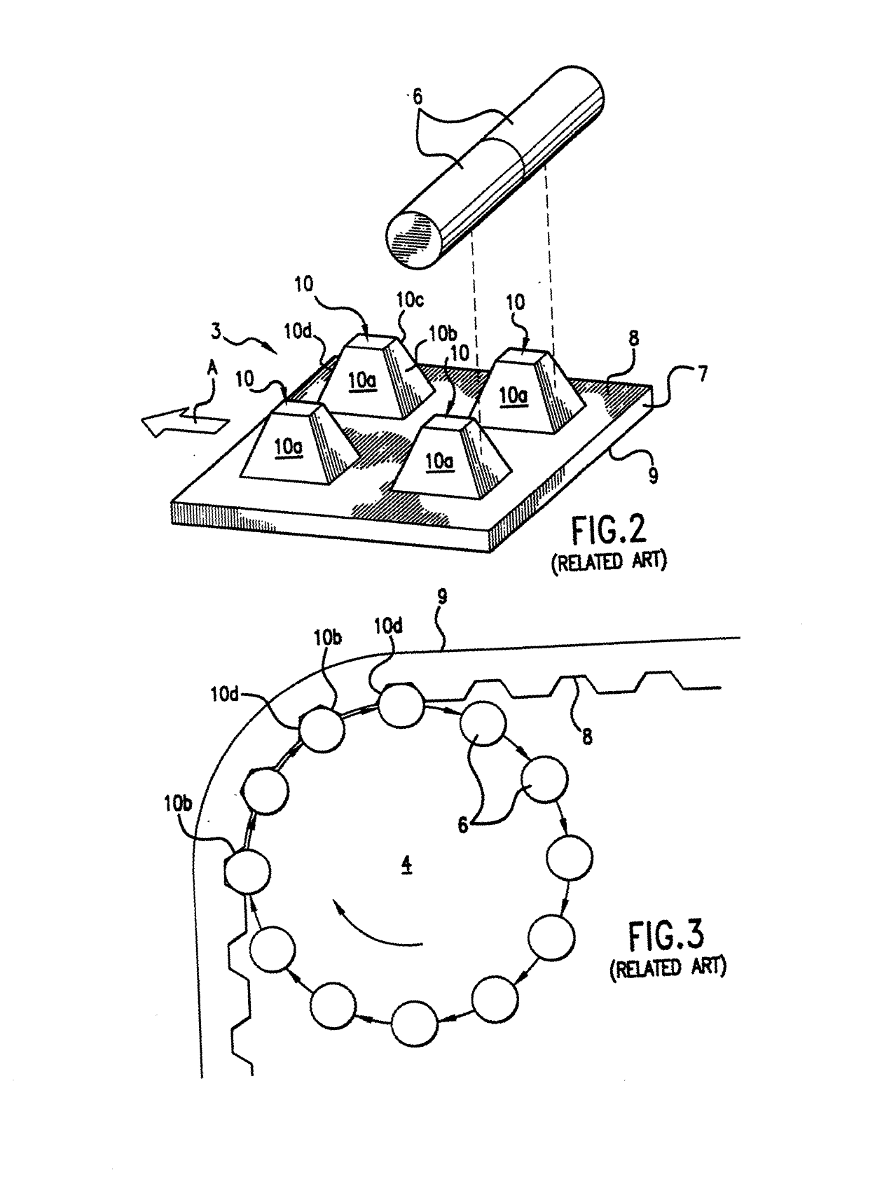

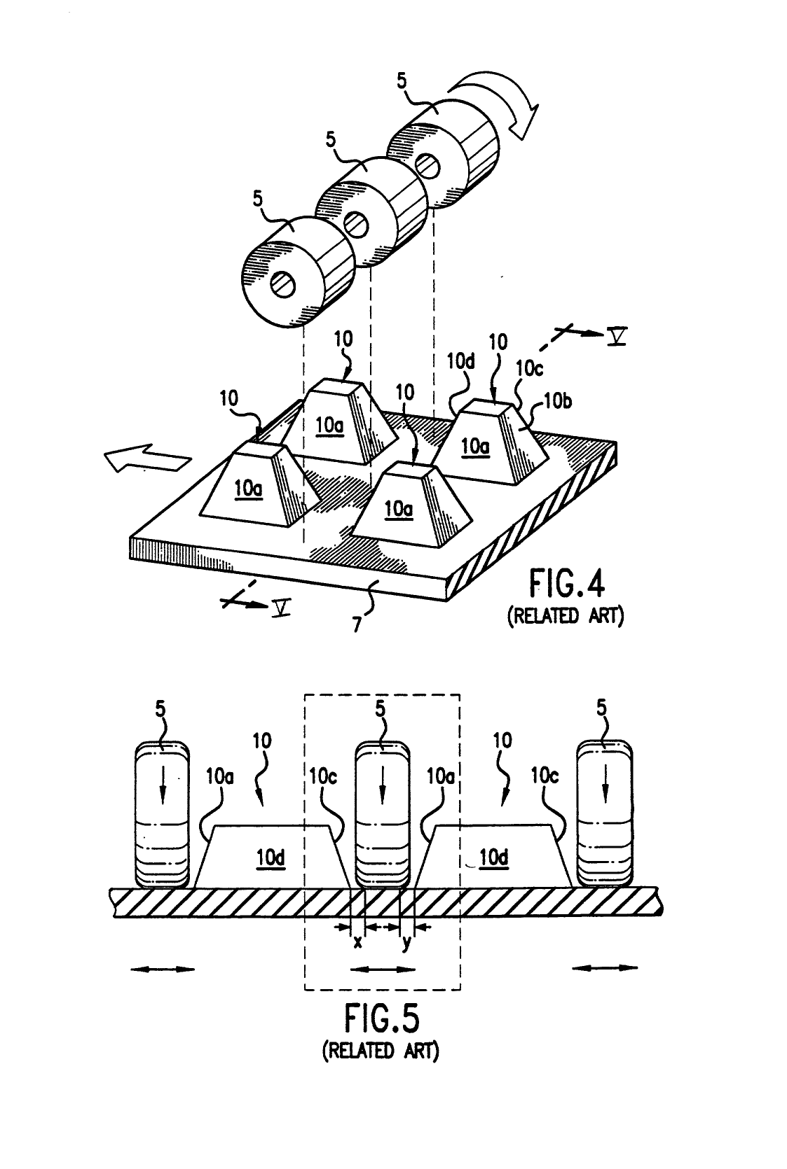

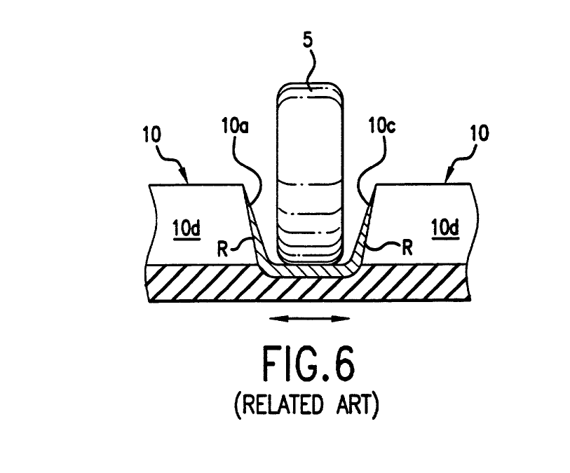

Each of the drive lugs 10A includes an inside longitudinal face 12 and an outside longitudinal face 14. Although not shown in FIG. 7, each of the drive lugs 10A also includes at least one drive face similar to the related art shown in FIGS. 2-5. The width of each drive face should be from about 2 to about 4 times the width of the longitudinal faces 12 and 14. While the longitudinal faces 12 and 14 of the drive lugs 10A in the first exemplary embodiment are shown as planar, angled surfaces, it should be understood that any suitable configuration of the longitudinal faces 12 and 14 may be used with the invention. For example, the invention may be implemented with the drive lug configuration disclosed in copending U.S. patent application Ser. No. 09/347,571, which is incorporated herein by reference in its entirety.

The endless track 3A shown in FIG. 7 includes a unitary reinforcing brace 100 capable of simultaneously protecting at least two drive lugs 10A. The unitary reinforcing brace 100 is made from a wear-resistant material and may have a uniform thickness. The unitary reinforcing brace 100 includes a solid connecting section 110.

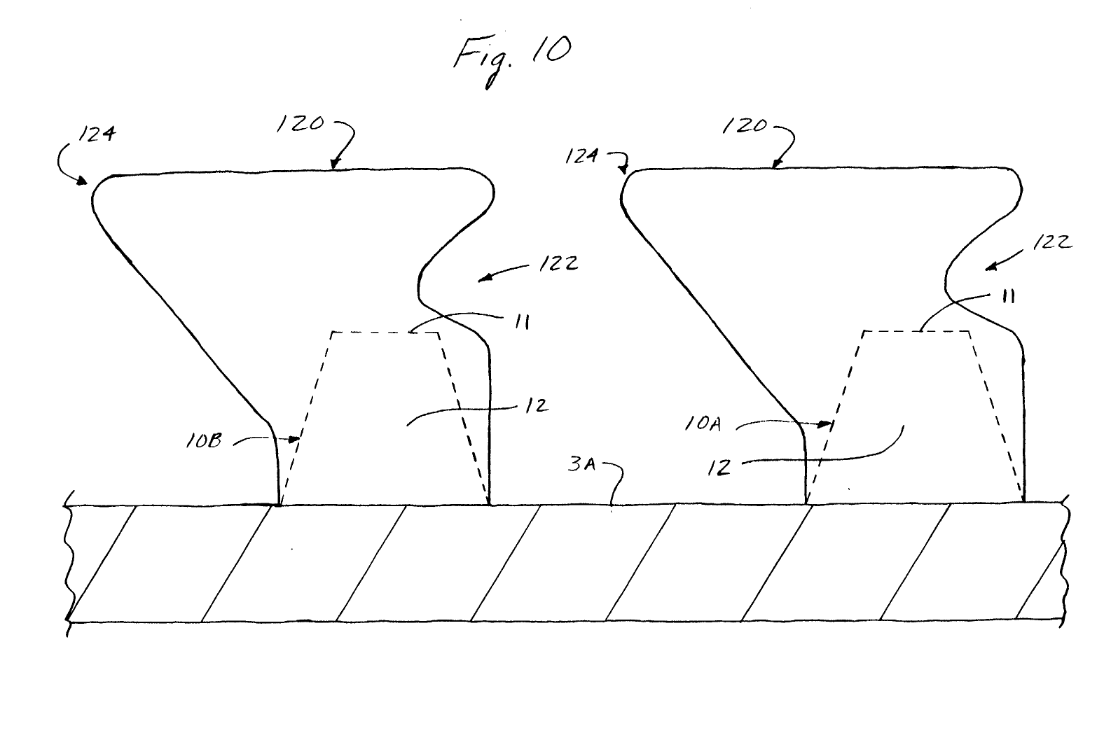

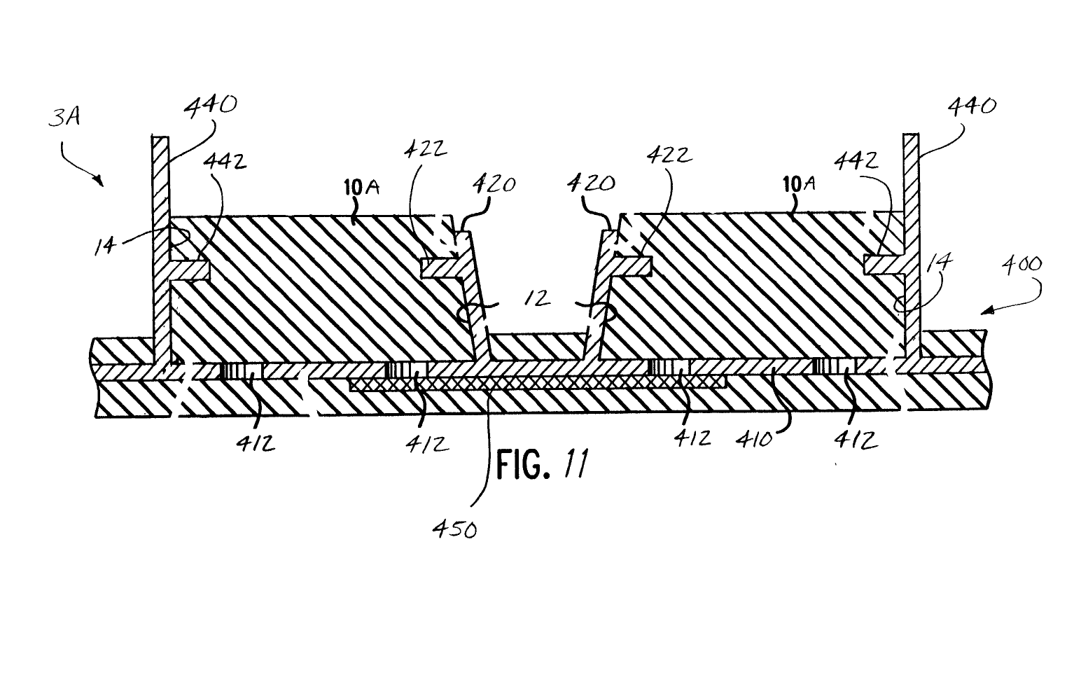

A guiding brace 120 is provided adjacent the inside longitudinal face 12 of each drive lug 10A. As shown, the guiding brace 120 extends beyond the inside longitudinal face 12 in a direction away from the endless track 3A. As further described below with respect to FIG. 10, the guiding brace 120 also extends beyond the inside longitudinal face 12 in a direction towards a longitudinally adjacent drive lug. In the first exemplary embodiment of FIG. 7, the guiding brace 120 is at least partially embedded in the endless track 3A. The guiding brace 120 may have a chamfered or beveled edge 122 that facilitates initial placement of the roller wheels properly between the drive lugs 10A and/or helps maintain the roller wheels between the drive lugs 10A.

As described further below, the reinforcing brace 100 of the first exemplary embodiment, as well as the other exemplary embodiments, may be implemented by any suitable configuration. For example, the reinforcing brace of this invention may be implemented by any of the various configurations disclosed in copending U.S. patent application Ser. No. 09/271,150, which is incorporated herein by reference in its entirety.

A flange 140 is provided adjacent the outside longitudinal face 14 of each drive lug 10A. As shown in FIG. 7, each flange 140 extends from the connecting section 110 and is at least partially embedded in the endless track 3A. The flanges 140 and the guiding braces 120 may be attached to the connecting section 110 by, for example, welding, thereby improving the structural integrity of the endless track 3A as well as the rigidity of the reinforcing brace 100.

The flanges 140 and the guiding braces 120 are made of a wear-resistant material. Thus, the flanges 140 and the guiding braces 120 will not wear away from frictional contact and serve to protect the outside longitudinal faces 14 and the inside longitudinal faces 12, respectively, of the drive lugs 10A from wear resulting from contact with the roller wheels. Even if the drive faces of the drive lugs 10A are partially worn away by contact with drive rollers (not shown), edges of the flanges 140 and the guiding braces 120 will be contacted by the drive rollers, thereby reducing slippage of the planetary drive system 4 while attempting to drive the endless track 3A.

Additionally, the guiding braces 120 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 120 guide the roller wheels to help maintain the axes of the roller wheels substantially perpendicular to the longitudinal moving direction of the endless track 3A.

The unitary reinforcing brace 100 of FIG. 7 includes a rib 150 protruding from the connecting section 1 10 in a direction toward the exterior surface 9A of the endless track 3A. The rib 150 is located at a position spanning at least a region of the connecting section 110 between the adjacent drive lugs 10A. The rib 150 provides the unitary reinforcing brace 100 with additional strength, for example, when the tracked vehicle is driven over an impediment, such as, for example, a rock or the like.

FIG. 8 is a cross-sectional view of an endless track 3A according to a second exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

The endless track 3A shown in FIG. 8 includes a unitary reinforcing brace 200 capable of simultaneously protecting at least two drive lugs 10A. The unitary reinforcing brace 200 is made from a wear-resistant material and may have a uniform thickness. The unitary reinforcing brace 200 includes a solid connecting section 210.

A guiding brace 240 is provided adjacent the outside longitudinal face 14 of each drive lug 10A. As shown, the guiding brace 240 extends beyond the outside longitudinal face 14 in a direction away from the endless track 3A. As further described below with respect to FIG. 10, the guiding brace 240 also extends beyond the outside longitudinal face 14 in a direction towards a longitudinally adjacent drive lug. In the second exemplary embodiment of FIG. 8, the guiding brace 240 is at least partially embedded in the endless track 3A. The guiding brace 240 may have a chamfered or beveled edge 242 that facilitates initial placement of the roller wheels properly relative to the drive lugs 10A and/or helps maintain the roller wheels in proper position relative to the drive lugs 10A.

A flange 220 is provided adjacent the inside longitudinal face 12 of each drive lug 10A. As shown in FIG. 8, each flange 220 extends from the connecting section 210 and is at least partially embedded in the endless track 3A. The flanges 220 and the guiding braces 240 may be attached to the connecting section 210 by, for example, welding, thereby improving the structural integrity of the endless track 3A as well as the rigidity of the reinforcing brace 200.

The flanges 220 and the guiding braces 240 are made of a wear-resistant material. Thus, the flanges 220 and the guiding braces 240 will not wear away from frictional contact and serve to protect the inside longitudinal faces 12 and the outside longitudinal faces 14, respectively, of the drive lugs 10A from wear resulting from contact with the roller wheels. Even if the drive faces of the drive lugs 10A are partially worn away by contact with drive rollers (not shown), edges of the flanges 220 and the guiding braces 240 will be contacted by the drive rollers, thereby reducing slippage of the planetary drive system 4 while attempting to drive the endless track 3A.

Additionally, the guiding braces 240 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 240 guide the roller wheels to help maintain the axes of the roller wheels substantially perpendicular to the longitudinal moving direction of the endless track 3A.

The unitary reinforcing brace 200 of FIG. 8 includes a rib 250 protruding from the connecting section 210 in a direction toward the exterior surface 9A of the endless track 3A. The rib 250 is located at a position spanning at least a region of the connecting section 210 between the adjacent drive lugs 10A. The rib 250 provides the unitary reinforcing brace 200 with additional strength, for example, when the tracked vehicle is driven over an impediment, such as, for example, a rock or the like.

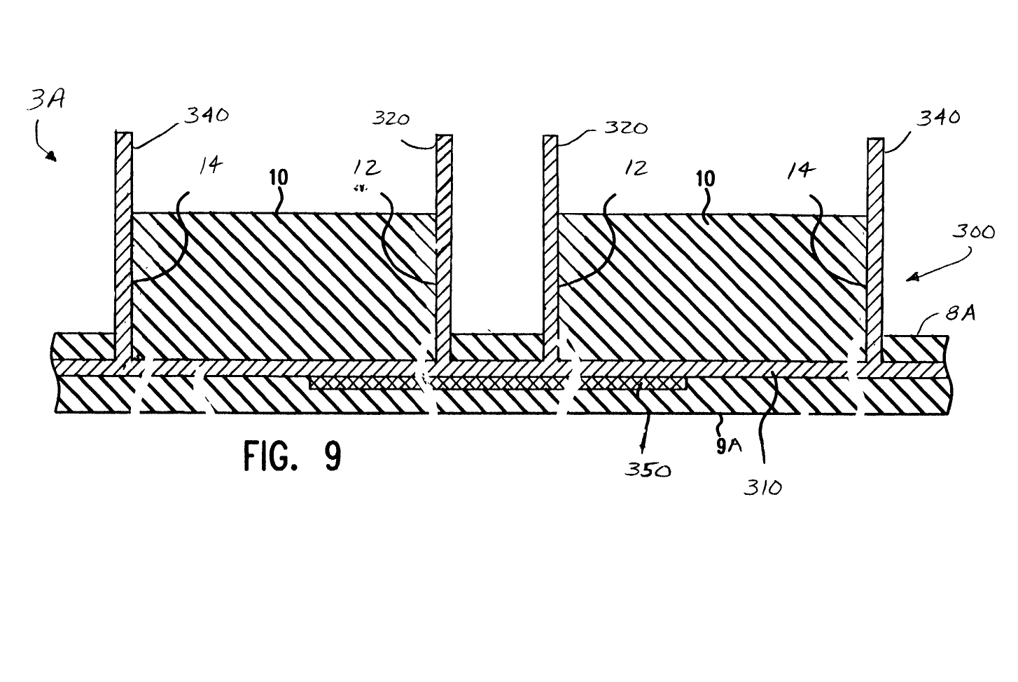

FIG. 9 is a cross-sectional view of an endless track 3A according to a third exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

The endless track 3A shown in FIG. 9 includes a unitary reinforcing brace 300 capable of simultaneously protecting at least two drive lugs 10A. The unitary reinforcing brace 300 is made from a wear-resistant material and may have a uniform thickness. The unitary reinforcing brace 300 includes a solid connecting section 310. A first guiding brace 320 is provided adjacent the inside longitudinal face 12 of each drive lug 10A. As shown, the first guiding brace 320 extends beyond the inside longitudinal face 12 in a direction away from the endless track 3A. As further described below with respect to FIG. 10, the first guiding brace 320 also extends beyond the inside longitudinal face 12 in a direction towards a longitudinally adjacent drive lug. In the third exemplary embodiment of FIG. 9, the first guiding brace 320 is at least partially embedded in the endless track 3A.

A second guiding brace 340 is provided adjacent the outside longitudinal face 14 of each drive lug 10A. As shown, the second guiding brace 340 extends beyond the outside longitudinal face 14 in a direction away from the endless track 3A. As further described below with respect to FIG. 10, the second guiding brace 340 also extends beyond the outside longitudinal face 14 in a direction towards a longitudinally adjacent drive lug. In the third exemplary embodiment of FIG. 9, the second guiding brace 340 is at least partially embedded in the endless track 3A.

The first and second guiding braces 320 and 340 may be attached to the connecting section 310 by, for example, welding, thereby improving the structural integrity of the endless track 3A as well as the rigidity of the reinforcing brace 300. The first and second guiding braces 320 and 340 are made of a wear-resistant material. Thus, the first and second guiding braces 320 and 340 will not wear away from frictional contact and serve to protect the outside longitudinal faces 12 and the inside longitudinal faces 14, respectively, of the drive lugs 10A from wear resulting from contact with the roller wheels. Even if the drive faces of the drive lugs 10A are partially worn away by contact with drive rollers (not shown), edges of the first and second guiding braces 320 and 340 will be contacted by the drive rollers, thereby reducing slippage of the planetary drive system 4 while attempting to drive the endless track 3A.

Additionally, the first and second guiding braces 320 and 340 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The first and second guiding braces 320 and 340 guide the roller wheels to help maintain the axes of the roller wheels substantially perpendicular to the longitudinal moving direction of the endless track 3A.

The unitary reinforcing brace 300 of FIG. 9 includes a rib 350 protruding from the connecting section 310 in a direction toward the exterior surface 9A of the endless track 3A. The rib 350 is located at a position spanning at least a region of the connecting section 310 between the adjacent drive lugs 10A. The rib 350 provides the unitary reinforcing brace 300 with additional strength, for example, when the tracked vehicle is driven over an impediment, such as, for example, a rock or the like.

FIG. 10 is a cross-sectional view of an endless track according to the first exemplary embodiment shown in FIG. 7, as taken along section line VII-VII, having an exemplary embodiment of the guiding brace 120. As shown, the guiding brace 120 associated with the drive lug 10A extends beyond the inside longitudinal face 12 in a direction away from the endless track 3A and in a direction towards a longitudinally adjacent drive lug 10B.

The guiding braces 120 are designed to allow a desired movement of the endless track around the drive system. For example, each guiding brace 120 may include a notch or recess 122 on a first side and a protrusion 124 on a second side. The notch 122 of the longitudinally adjacent drive lug 10B accommodates the protrusion 124 of the drive lug 10A as the endless track 3A is bent around the drive system.

When a second guiding brace (not shown) is associated with the drive lug 10A or with a transversely adjacent drive lug (not shown), then the second guiding brace may be arranged to extend in a second direction towards a longitudinally adjacent drive lug that is substantially opposite the direction in which the guiding brace 120 extends. In this manner, when guiding braces are associated with longitudinally adjacent drive lugs, any gap between the guiding braces 120 of the longitudinally adjacent drive lugs will be alternated with the gap between the second guiding braces of the longitudinally adjacent drive lugs.

It should be understood that the guiding brace according to each exemplary embodiment described herein may be implemented as shown in FIG. 10 or any other suitable configuration. For example, while the guiding brace 120 shown in FIG. 10 extends beyond the inside longitudinal face 12 in a direction away from the endless track 3A, the guiding brace 120 may be flush with, or withdrawn from, a top edge 11 of the drive lug 10. Also, any suitable shape that allows the desired movement of the endless track 3A around the drive system may be used.

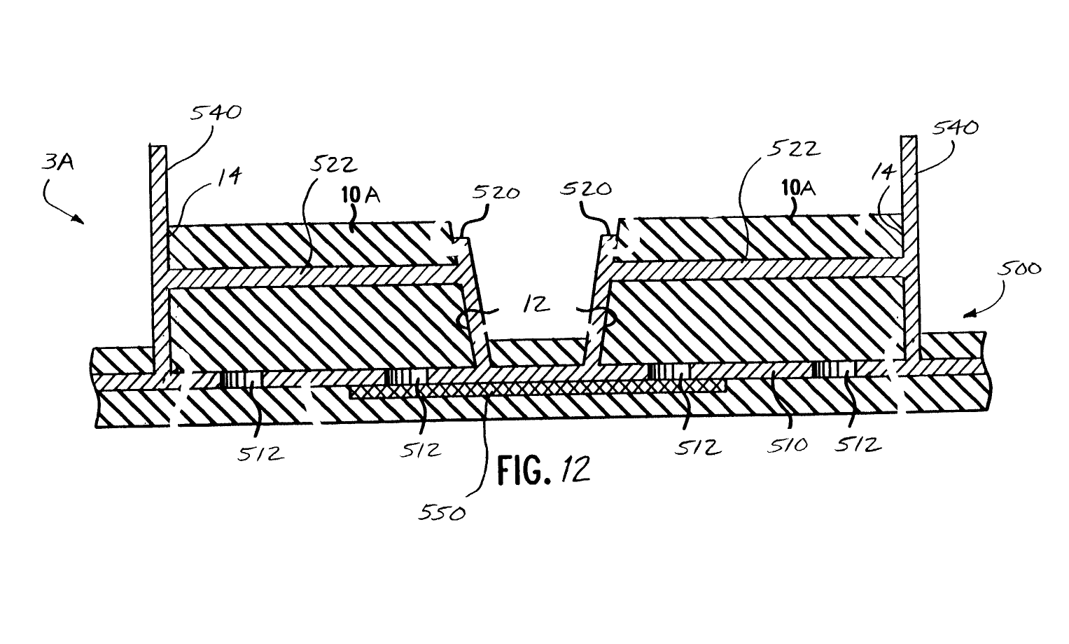

FIG. 11 is a cross-sectional view of an endless track 3A according to a fourth exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

The endless track 3A shown in FIG. 11 includes a unitary reinforcing brace 400 capable of simultaneously protecting at least two drive lugs 10A. The unitary reinforcing brace 400 is made from a wear-resistant material and may have-a uniform thickness. The unitary reinforcing brace 400 includes a connecting section 410 with at least one aperture 412.

As shown in FIG. 11, the multiple apertures 412 may be provided, for example, proximate the drive lugs 10A. The apertures 412 are configured to interact with a portion of the endless track 3A and promote locking of the reinforcing brace 400 embedded in the endless track 3A.

A guiding brace 440 is provided adjacent the outside longitudinal face 14 of each drive lug 10A. As shown, the guiding brace 440 extends beyond the outside longitudinal face 14 in a direction away from the endless track 3A. As described above with respect to FIG. 10, the guiding brace 440 also extends beyond the outside longitudinal face 14 in a direction towards a longitudinally adjacent drive lug. In the fourth exemplary embodiment of FIG. 11, the guiding brace 440 is at least partially embedded in the endless track 3A.

A flange 420 is provided adjacent the inside longitudinal face 12 of each drive lug 10A. As shown in FIG. 11, each flange 420 extends from the connecting section 410 and is at least partially embedded in the endless track 3A. The flanges 420 and the guiding braces 440 may be attached to the connecting section 410 by, for example, welding, thereby improving the structural integrity of the endless track 3A as well as the rigidity of the reinforcing brace 400.

The flanges 420 and the guiding braces 440 are at least partially embedded in a main portion of the endless track 3A, as well as in the drive lugs 10A. To this end, each flange 420 includes a lateral protrusion 422 that extends into the drive lug 10A. Similarly, each guiding brace 440 includes a lateral protrusion 442 that extends into the drive lug 10A. The lateral protrusions 422 and 442 help to secure the flanges 420 and the guiding braces 440, respectively, relative to the longitudinal faces 12 and 14 of the drive lugs 10A.

The flanges 420 and the guiding braces 440 are made of a wear-resistant material. Thus, the flanges 420 and the guiding braces 440 will not wear away from frictional contact and serve to protect the inside longitudinal faces 12 and the outside longitudinal faces 14, respectively, of the drive lugs 10A from wear resulting from contact with the roller wheels. Even if the drive faces of the drive lugs 10A are partially worn away by contact with drive rollers (not shown), edges of the flanges 420 and the guiding braces 440 will be contacted by the drive rollers, thereby reducing slippage of the planetary drive system 4 while attempting to drive the endless track 3A.

Additionally, the guiding braces 440 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 440 guide the roller wheels to help maintain the axes of the roller wheels substantially perpendicular to the longitudinal moving direction of the endless track 3A.

The unitary reinforcing brace 400 of FIG. 11 also includes a rib 450 protruding from the connecting section 410 in a direction toward the exterior surface 9A of the endless track 3A. The rib 450 is located at a position spanning at least a region of the connecting section 410 between the adjacent drive lugs 10A. The rib 450 provides the unitary reinforcing brace 400 with additional strength, for example, when the tracked vehicle is driven over an impediment, such as, for example, a rock or the like.

FIG. 12 is a cross-sectional view of an endless track 3A according to a fifth exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

The endless track 3A shown in FIG. 12 includes a unitary reinforcing brace 500 capable of simultaneously protecting at least two drive lugs 10A. The unitary reinforcing brace 500 is made from a wear-resistant material and may have a uniform thickness. The unitary reinforcing brace 500 includes a connecting section 510 with at least one aperture 512.

As shown in FIG. 12, the multiple apertures 512 may be provided, for example, proximate the drive lugs 10A. The apertures 512 are configured to interact with a portion of the endless track 3A and promote locking of the reinforcing brace 500 embedded in the endless track 3A.

A guiding brace 540 is provided adjacent the outside longitudinal face 14 of each drive lug 10A. As shown, the guiding brace 540 extends beyond the outside longitudinal face 14 in a direction away from the endless track 3A. As described above with respect to FIG. 10, the guiding brace 540 also extends beyond the outside longitudinal face 14 in a direction towards a longitudinally adjacent drive lug. In the fifth exemplary embodiment of FIG. 12, the guiding brace 540 is at least partially embedded in the endless track 3A.

A flange 520 is provided adjacent the inside longitudinal face 12 of each drive lug 10A. As shown in FIG. 12, each flange 520 extends from the connecting section 510 and is at least partially embedded in the endless track 3A. The flanges 520 and the guiding braces 540 may be attached to the connecting section 510 by, for example, welding, thereby improving the structural integrity of the endless track 3A as well as the rigidity of the reinforcing brace 500.

The flanges 520 and the guiding braces 540 are made of a wear-resistant material. Thus, the flanges 520 and the guiding braces 540 will not wear away from frictional contact and serve to protect the inside longitudinal faces 12 and the outside longitudinal faces 14, respectively, of the drive lugs 10A from wear resulting from contact with the roller wheels. Even if the drive faces of the drive lugs 10A are partially worn away by contact with drive rollers (not shown), edges of the flanges 520 and the guiding braces 540 will be contacted by the drive rollers, thereby reducing slippage of the planetary drive system 4 while attempting to drive the endless track 3A.

Additionally, the guiding braces 540 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 540 guide the roller wheels to help maintain the axes of the roller wheels substantially perpendicular to the longitudinal moving direction of the endless track 3A.

The unitary reinforcing brace 500 of FIG. 12 also includes a rib 550 protruding from the connecting section 510 in a direction toward the exterior surface 9A of the endless track 3A. The rib 550 is located at a position spanning at least a region of the connecting section 510 between the adjacent drive lugs 10A. The rib 550 provides the unitary reinforcing brace 500 with additional strength, for example, when the tracked vehicle is driven over an impediment, such as, for example, a rock or the like.

Thus, the fifth exemplary embodiment is substantially similar to the fourth exemplary embodiment shown in FIG. 11, except that a support rod 522 extends between the flange 520 and the guiding brace 540 through each of the drive lugs 10A. The support rod 522 may be attached to the flange 520 and the guiding brace 540, for example, by welding. In addition to helping to secure the flanges 520 and the guiding braces 540, respectively, relative to the longitudinal faces 12 and 14 of the drive lugs 10A, the support rod 522 maintains a distance between the flange 520 and the guiding brace 540, reducing the possibility of compression of the drive lug 10A or separation of the flange 520 and the guiding brace 540.

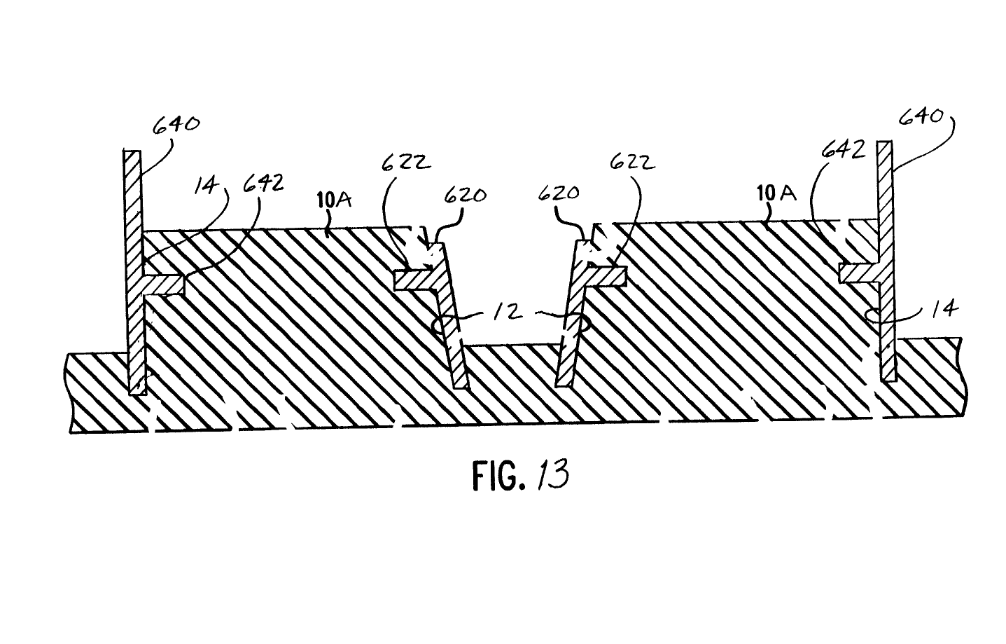

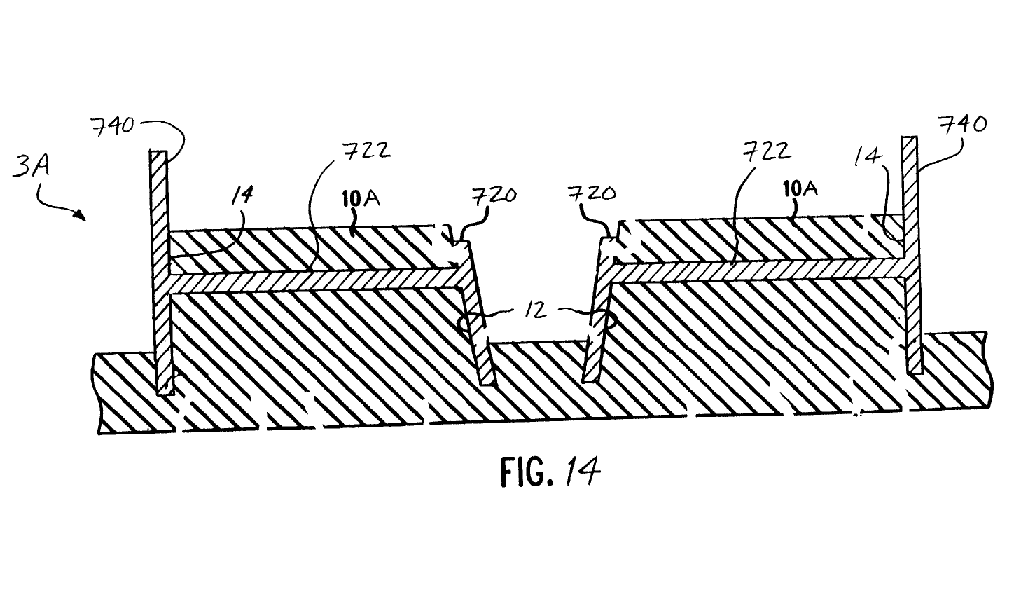

FIG. 13 is a cross-sectional view of an endless track 3A according to a sixth exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

A guiding brace 640 is provided adjacent the outside longitudinal face 14 of each drive lug 10A. As shown, the guiding brace 640 extends beyond the outside longitudinal face 14 in a direction away from the endless track 3A. As described above with respect to FIG. 10, the guiding brace 640 also extends beyond the outside longitudinal face 14 in a direction towards a longitudinally adjacent drive lug. In the sixth exemplary embodiment of FIG. 13, the guiding brace 640 is at least partially embedded in the endless track 3A.

A flange 620 is provided adjacent the inside longitudinal face 12 of each drive lug 10A. As shown in FIG. 13, each flange 620 is at least partially embedded in the endless track 3A. In particular, the flanges 620 and the guiding braces 640 are at least partially embedded in a main portion of the endless track 3A, as well as in the drive lugs 10A. To this end, each flange 620 includes a lateral protrusion 622 that extends into the drive lug 10A. Similarly, each guiding brace 640 includes a lateral protrusion 642 that extends into the drive lug 10A. The lateral protrusions 622 and 642 help to secure the flanges 620 and the guiding braces 640, respectively, relative to the longitudinal faces 12 and 14 of the drive lugs 10A. Thus, sixth exemplary embodiment of the endless track 3A shown in FIG. 13 does not include a unitary reinforcing brace.

The flanges 620 and the guiding braces 640 are made of a wear-resistant material. Thus, the flanges 620 and the guiding braces 640 will not wear away from frictional contact and serve to protect the inside longitudinal faces 12 and the outside longitudinal faces 14, respectively, of the drive lugs 10A from wear resulting from contact with the roller wheels. Even if the drive faces of the drive lugs 10A are partially worn away by contact with drive rollers (not shown), edges of the flanges 620 and the guiding braces 640 will be contacted by the drive rollers, thereby reducing slippage of the planetary drive system 4 while attempting to drive the endless track 3A.

Additionally, the guiding braces 640 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 640 guide the roller wheels to help maintain the axes of the roller wheels substantially perpendicular to the longitudinal moving direction of the endless track 3A.

FIG. 14 is a cross-sectional view of an endless track 3A according to a seventh exemplary embodiment of the invention. As with the first exemplary embodiment shown in FIG. 7, each of the drive lugs 10A includes the inside and outside longitudinal faces 12 and 14. Again, while the longitudinal faces 12 and 14 of the drive lugs 10A in the second exemplary embodiment are shown as planar, angled surfaces, it should be understood that any suitable configuration of the longitudinal faces 12 and 14 may be used with the invention. For example, the invention may be implemented with the drive lug configuration disclosed in the incorporated '571 application.

A guiding brace 740 is provided adjacent the outside longitudinal face 14 of each drive lug 10A. As shown, the guiding brace 740 extends beyond the outside longitudinal face 14 in a direction away from the endless track 3A. As described above with respect to FIG. 10, the guiding brace 740 also extends beyond the outside longitudinal face 14 in a direction towards a longitudinally adjacent drive lug. In the seventh exemplary embodiment of FIG. 14, the guiding brace 740 is at least partially embedded in the endless track 3A.

A flange 720 is provided adjacent the inside longitudinal face 12 of each drive lug 10A. As shown in FIG. 14, each flange 720 is at least partially embedded in the endless track 3A. As with the sixth exemplary embodiment of the endless track 3A shown in FIG. 13, the seventh exemplary embodiment does not include a unitary reinforcing brace.

The flanges 720 and the guiding braces 740 are made of a wear-resistant material. Thus, the flanges 720 and the guiding braces 740 will not wear away from frictional contact and serve to protect the inside longitudinal faces 12 and the outside longitudinal faces 14, respectively, of the drive lugs 10A from wear resulting from contact with-the roller wheels. Even if the drive faces of the drive lugs 10A are partially worn away by contact with drive rollers (not shown), edges of the flanges 720 and the guiding braces 740 will be contacted by the drive rollers, thereby reducing slippage of the planetary drive system 4 while attempting to drive the endless track 3A.

Additionally, the guiding braces 740 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 740 guide the roller wheels to help maintain the axes of the roller wheels substantially perpendicular to the longitudinal moving direction of the endless track 3A.

Thus, the seventh exemplary embodiment is substantially similar to the sixth exemplary embodiment shown in FIG. 13, except that a support rod 722 extends between the flange 720 and the guiding brace 740 through each of the drive lugs 10A. The support rod 722 may be attached to the flange 720 and the guiding brace 740, for example, by welding. In addition to helping to secure the flanges 720 and the guiding braces 740, respectively, relative to the longitudinal faces 12 and 14 of the drive lugs 10A, the support rod 722 maintains a distance between the flange 720 and the guiding brace 740, reducing the possibility of compression of the drive lug 10A or separation of the flange 720 and the guiding brace 740.

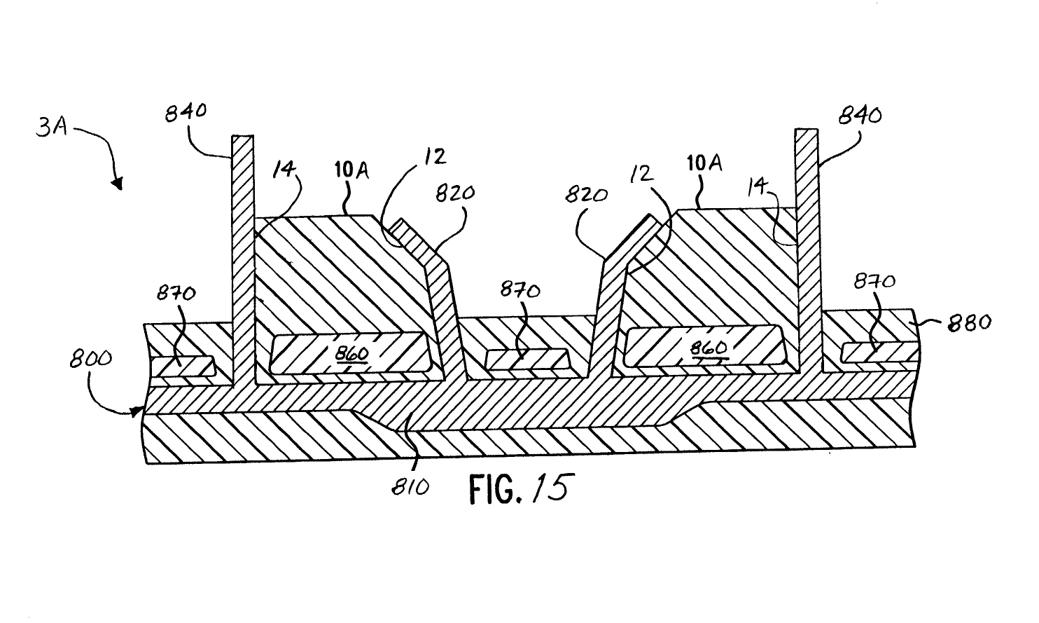

FIG. 15 is a cross-sectional view of an endless track 3A according to an eighth exemplary embodiment of the invention. As with the first exemplary embodiment shown in FIG. 7, each of the drive lugs 10A includes the inside and outside longitudinal faces 12 and 14. In the eighth exemplary embodiment shown in FIG. 15, however, the longitudinal faces 12 and 14 are configured according to an embodiment of the drive lugs 10A disclosed in the incorporated '571 application.

The endless track 3A shown in FIG. 15 includes a unitary reinforcing brace 800 capable of simultaneously protecting at least two drive lugs 10A. The unitary reinforcing brace 800 is made from a wear-resistant material and includes a connecting section 810. As shown in FIG. 15, the connecting section 810 of the unitary reinforcing brace 800 may be thicker in a region at least between the adjacent drive lugs 10A. The extra thickness provides the unitary reinforcing brace 800 with additional strength, for example, when the tracked vehicle is driven over an impediment, such as, for example, a rock or the like.

A guiding brace 840 is provided adjacent the outside longitudinal face 14 of each drive lug 10A. As shown, the guiding brace 840 extends beyond the outside longitudinal face 14 in a direction away from the endless track 3A. As described above with respect to FIG. 10, the guiding brace 840 also extends beyond the outside longitudinal face 14 in a direction towards a longitudinally adjacent drive lug. In the eighth exemplary embodiment of FIG. 15, the guiding brace 840 is at least partially embedded in the endless track 3A.

A flange 820 is provided adjacent the inside longitudinal face 12 of each drive lug 10A. As shown in FIG. 15, each flange 820 extends from the connecting section 810 and is at least partially embedded in the endless track 3A. The flanges 820 and the guiding braces 840 may be attached to the connecting section 810 by, for example, welding, thereby improving the structural integrity of the endless track 3A as well as the rigidity of the reinforcing brace 800.

The flanges 820 and the guiding braces 840 are made of a wear-resistant material. Thus, the flanges 820 and the guiding braces 840 will not wear away from frictional contact and serve to protect the inside longitudinal faces 12 and the outside longitudinal faces 14, respectively, of the drive lugs 10A from wear resulting from contact with the roller wheels. Even if the drive faces of the drive lugs 10A are partially worn away by contact with drive rollers (not shown), edges of the flanges 820 and the guiding braces 840 will be contacted by the drive rollers, thereby reducing slippage of the planetary drive system 4 while attempting to drive the endless track 3A.

Additionally, the guiding braces 840 serve to guide the roller wheels, reducing the likelihood that the roller wheels vary substantially from their longitudinal path adjacent the drive lugs 10A. If the axes of the roller wheels are allowed to vary from their substantially perpendicular orientation to the longitudinal moving direction of the endless track 3A, the roller wheels are angled into the drive lugs 10A, risking damage to the drive lugs 10A and potential derailment of the endless track 3A. The guiding braces 840 guide the roller wheels to help maintain the axes of the roller wheels substantially perpendicular to the longitudinal moving direction of the endless track 3A.

The endless track 3A of the eighth exemplary embodiment is reinforced with belts 860 and 870 extending within the endless track 3A in the longitudinal direction. The belts 860 and 870 can be made from a polymeric material, for example, kevlar, that is different than the polymeric material from which a body 880 of the endless track 3A is made. Furthermore, the belts 860 positioned in a vicinity of or within the drive lugs 10A can be larger, for example, thicker, than the belts 870 between and outside the drive lugs 10A. Moreover, the belts 860 and 870 can also be cables and/or the can be made of a strength enhanced material.

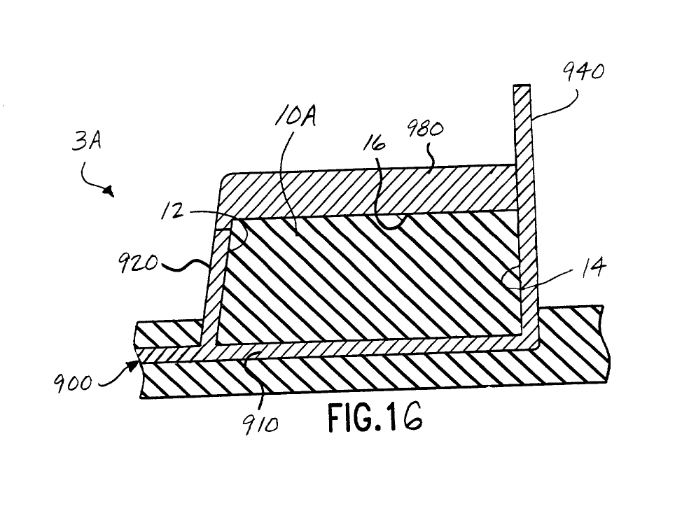

FIGS. 16 is a partial cross-sectional view of an endless track 3A according to a ninth exemplary embodiment of the invention. As with the second exemplary embodiment shown in FIG. 8, each of the drive lugs 10A includes the inside and outside longitudinal faces 12 and 14 and the endless track 3A includes a unitary reinforcing brace 900 capable of simultaneously protecting at least two drive lugs 10A. Also, a guiding brace 940 is provided adjacent the outside longitudinal face 14 of each drive lug 10A. The guiding brace 940 extends beyond the outside longitudinal face 14 in a direction away from the endless track 3A. The guiding brace 940 also extends beyond the outside longitudinal face 14 in a direction towards a longitudinally adjacent drive lug and is at least partially embedded in the endless track 3A.

As with the second exemplary embodiment shown in FIG. 8, a flange 920 is provided adjacent the inside longitudinal face 12 of each drive lug 10A. Each flange 920 extends from the connecting section 910 and is at least partially embedded in the endless track 3A. The flanges 920 and the guiding braces 940 function as described above with respect to the second exemplary embodiment shown in FIG. 8.

The ninth embodiment differs from the second exemplary embodiment shown in FIG. 8 by including a cap 980 that protects a top portion 16 of the drive lug 10A from wear due to the frictional engagement with the drive rollers and or roller wheels of the drive system. The cap 980 is made of a wear-resistant material, such as metal and/or plastic materials. However, any material that can resist degradation or erosion due to the engagement of the drive rollers and/or the frictional contact with the roller wheels would be suitable. The cap 980 is attached, for example, by welding to a top portion of the flange 920 and a portion of the guiding brace 940.

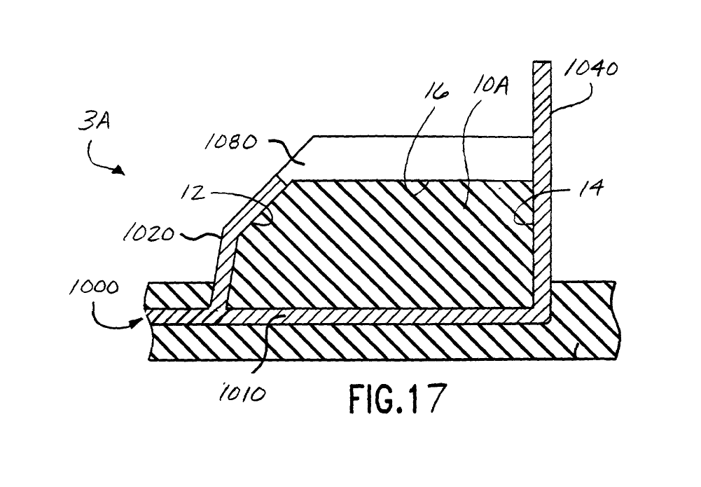

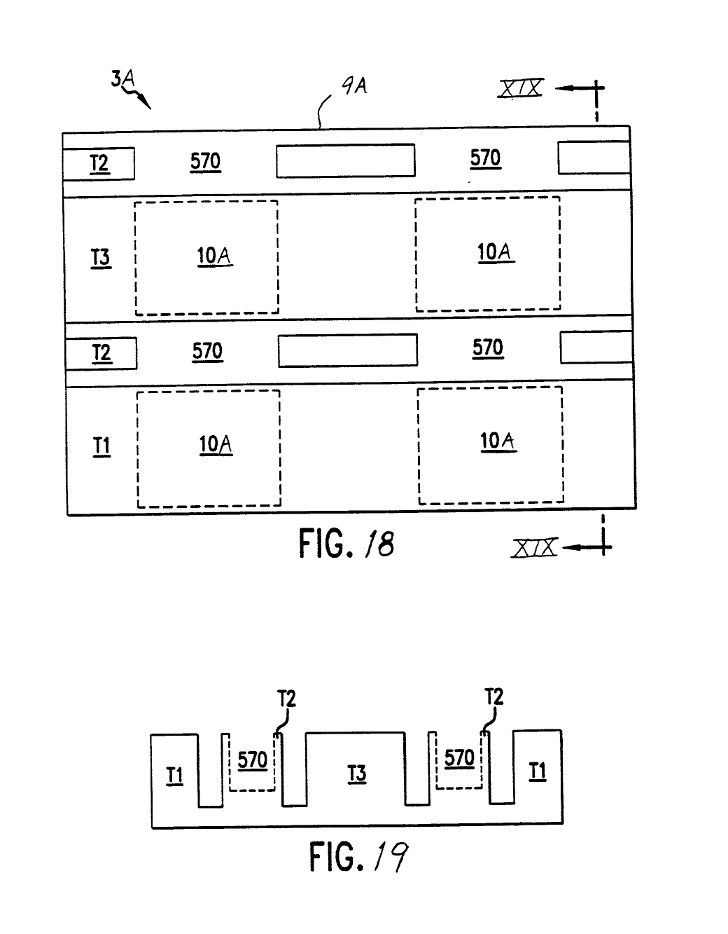

FIG. 17 is a partial cross-sectional view of an endless track 3A according to a tenth exemplary embodiment of the invention. As with the ninth exemplary embodiment shown in FIG. 16, each of the drive lugs 10A includes the inside and outside longitudinal faces 12 and 14 and the endless track 3A includes a unitary reinforcing brace 1000 capable of simultaneously protecting at least two drive lugs 10A. Also, a guiding brace 1040 is provided adjacent the outside longitudinal face 14 of each drive lug 10A. The guiding brace 1040 extends beyond the outside longitudinal face 14 in a direction away from the endless track 3A. The guiding brace 1040 also extends beyond the outside longitudinal face 14 in a direction towards a longitudinally adjacent drive lug and is at least partially embedded in the endless track 3A.

As with the ninth exemplary embodiment shown in FIG. 16, a flange 1020 is provided adjacent the inside longitudinal face 12 of each drive lug 10A. Each flange 1020 extends from the connecting section 1010 and is at least partially embedded in the endless track 3A. The flanges 1020 and the guiding braces 1040 function as described above with respect to the second exemplary embodiment shown in FIG. 8.

As with the ninth exemplary embodiment shown in FIG. 16, a cap 1080 protects the top portion 16 of the drive lug 10A from wear due to the frictional engagement with the drive rollers and or roller wheels of the drive system. The tenth embodiment differs from the ninth exemplary embodiment shown in FIG. 16 by having drive lugs 10A configured as an embodiment described in the incorporated '571 application.

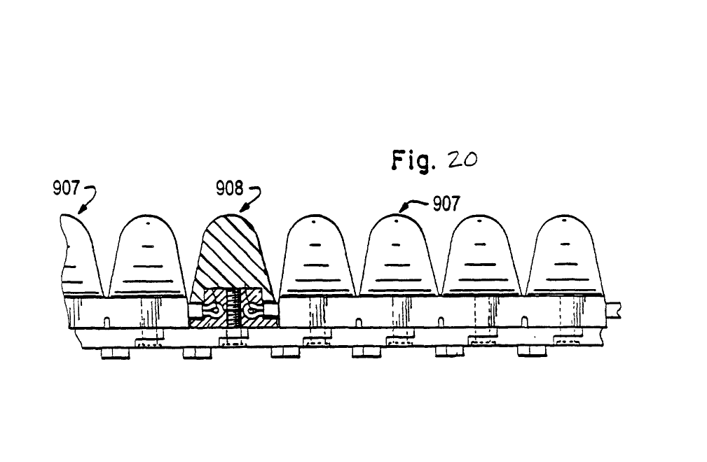

FIG. 20 is a plan view of an exemplary embodiment of the exterior surface 9A of the endless track 3A according to the invention. This feature can be used with any of the embodiments described in this application. As shown, a section 570 of the exterior surface 9A may be a cutout from the tread T2 between the treads T1 and T3 having the drive lugs 10A formed on a reverse surface thereof. The cutout section 570 of the exterior surface 9A not only reduces the amount of material needed to form the endless track 3A, but also provides the endless track 3A with additional space to channel any materials, such as rain, ground, dirt and the like, through tread T2 in the exterior surface 9A of the endless track 3A to provide better traction. The dash-lined boxes represent the drive lugs 10A, which extend from the interior surface (not shown) of the endless track 3A.

FIG. 21 is a cross-sectional view, as taken along section line XIX-XIX of FIG. 20. This shows the additional channeling provided by the relieved section 570 in the tread T2.

The reinforcing brace according to the invention is used to protect at least one drive lug of the endless track by embedding the reinforcing brace in the endless track a predetermined depth such that each flange extends away from the horizontal member and exterior surface of the endless track toward the endless drive system. To embed the reinforcing brace in the endless track, the pre-formed reinforcing brace is immersed in, e.g., a molten polymeric solution in a mold from which the endless track is formed. The reinforcing brace is positioned within the mold at a location in which a drive lug is formed such that each reinforcing brace encompasses a drive lug.

The polymeric solution with the reinforcing brace is then permitted to cool. Once the polymeric solution has cooled and solidified, the endless track with the reinforcing brace embedded therein is then removed from the mold. The endless track is then placed on a vehicle intended to travel across the ground.

Although the exemplary embodiments of the invention as set forth herein describe an endless track as a closed-loop integral assembly, the endless track 3A can be one or more sections 907 (see FIG. 20) interconnected by one or more master link joint assemblies, such as disclosed in U.S. Pat. Nos. 4,844,560 entitled “Endless Drive Track Joint Assembly”; 5,020,865 also entitled “Endless Drive Track Joint Assembly”; and 5,040,282 entitled “Method of Making A Modular Endless Track Drive System”, all issued to Edwards et al. and all incorporated herein by reference in their entireties. For example, the reinforcing cables or belts 860 and 870 of FIG. 15 can be arranged for this purpose around a grooved rod sandwiched between connected portions of a master link joint assembly 908 as shown in FIG. 20.

Furthermore, while positively driven endless tracks have been described, at least the reinforcing braces described herein can be used in friction driven tracks as well to protect each of a series of guide lugs, such as those used in Caterpillar's Challenger 85E and 95E tracks. Depending on the shape of the guide lugs, the flange of the reinforcing brace need not have an angled shape.

Also, while drive lugs that are formed integrally with the endless track have been described, removable tread elements are disclosed, for example, in U.S. Pat. No. 5,005,921 to Edwards et al. entitled “Endless Track Drive System,” for example, FIG. 7, which is incorporated herein in its entirety.

Additionally, while the endless tracks have generally been described with respect to two transversely adjacent drive lugs, it should be appreciated that the features of the various exemplary embodiments may be implemented for any desired number of drive lugs, including a single drive lug.

Thus, while the invention has been described in conjunction with the specific embodiments thereof, it is evident that many alternatives, modifications and variations will be apparent to those skilled in the art. Accordingly, the exemplary embodiments of the invention as set forth herein are intended to be illustrative, not limiting. Various changes may be made without departing from the spirit and scope of the invention.

What is claimed is:

1. An endless track, comprising:
an interior surface having a plurality of drive lugs attached to the interior surface, each of the drive lugs including a first longitudinal face, a second longitudinal face and at least one drive face; and
a guiding brace adjacent at least one of the first and second longitudinal faces of at least one of the drive lugs, the guiding brace extending beyond the at least one of the first and second longitudinal faces of the at least one of the drive lugs in a direction toward a longitudinally adjacent drive lug.

2. The endless track of claim 1, wherein the guiding brace extends beyond the at least one of the first and second longitudinal faces of the at least one of the drive lugs in a direction away from the interior surface.

3. The endless track of claim 1, wherein the guiding brace is secured to the at least one of the drive lugs by a lateral protrusion extending into the at least one of the drive lugs.

4. The endless track of claim 1, wherein the guiding brace is at least partially embedded in the endless track.

5. The endless track of claim 4, wherein the guiding brace is at least partially embedded in the at least one of the drive lugs.

6. The endless track of claim 1, further comprising:
a flange adjacent one of the first and second longitudinal faces of the at least one of the drive lugs, wherein the guiding brace is adjacent the other of the first and second longitudinal faces of the at least one of the drive lugs.

7. The endless track of claim 6, wherein the guiding brace is secured to the at least one of the drive lugs by a first lateral protrusion extending into the at least one of the drive lugs and the flange is secured to the at least one of the drive lugs by a second lateral protrusion extending into the at least one of the drive lugs.

8. The endless track of claim 6, further comprising:
a connecting section that connects the guiding brace and the flange.

9. The endless track of claim 8, wherein the connecting section is at least partially embedded in the endless track.

10. The endless track of claim 8, wherein the connecting section includes at least one aperture configured to interact with a portion of the endless track.

11. The endless track of claim 6, further comprising:
a rod extending between the guiding brace and the flange through the at least one of the drive lugs.

12. The endless track of claim 11, wherein the rod is attached to the guiding brace and the flange.

13. The endless track of claim 6, further comprising:
a cap extending over a top portion of the at least one of the drive lugs between the guiding brace and the flange.

14. The endless track of claim 13, wherein the cap is attached to the guiding brace and the flange.

15. The endless track of claim 1, wherein the guiding brace is a first guiding brace adjacent the first longitudinal face of the at least one of the drive lugs, and a second guiding brace is adjacent the second longitudinal face of the at least one of the drive lugs.

16. The endless track of claim 15, wherein the first and second guiding braces extend beyond the first and second longitudinal faces, respectively, of the at least one of the drive lugs in a direction away from the interior surface.

17. The endless track of claim 15, wherein the first guiding brace is secured to the at least one of the drive lugs by a first lateral protrusion extending into the at least one of the drive lugs and the second guiding brace is secured to the at least one of the drive lugs by a second lateral protrusion extending into the at least one of the drive lugs.

18. The endless track of claim 15, wherein the first guiding brace extends beyond the first longitudinal face in a first direction toward a longitudinally adjacent drive lug; and
wherein the second guiding brace extends beyond the second longitudinal face in a second direction toward the longitudinally adjacent drive lug.

19. The endless track of claim 18, wherein the second direction is substantially opposite the first direction.

20. The endless track of claim 18, wherein the second direction is substantially the same as the first direction.

21. The endless track of claim 15, further comprising:
a connecting section that connects the first guiding brace and the second guiding brace.

22. The endless track of claim 21, wherein the connecting section is at least partially embedded in the endless track.

23. The endless track of claim 21, wherein the connecting section includes at least one aperture configured to interact with a portion of the endless track.

24. The endless track of claim 15, further comprising:
a rod extending between the first guiding brace and the second guiding brace through the at least one of the drive lugs.

25. The endless track of claim 24, wherein the rod is attached to the first and second guiding braces.

26. The endless track of claim 15, further comprising:
a cap extending over a top portion of the at least one of the drive lugs between the first and second guiding braces.

27. The endless track of claim 26, wherein the cap is attached to the first and second guiding braces.

28. The endless track of claim 1, wherein the guiding brace is a first guiding brace adjacent at least one of the first and second longitudinal faces of the at least one of the drive lugs, and a second guiding brace is adjacent at least one of the first and second longitudinal faces of a transversely adjacent drive lug.

29. The endless track of claim 28, wherein the first and second guiding braces extend beyond the first and second longitudinal faces, respectively, of the at least one of the drive lugs in a direction away from the interior surface.

30. The endless track of claim 28, wherein the first guiding brace extends beyond the at least one of the first and second longitudinal faces of the at least one of the drive lugs in a first direction toward a first longitudinally adjacent drive lug; and
wherein the second guiding brace extends beyond the at least one of the first and second longitudinal faces of the transversely adjacent drive lug in a second direction toward a second longitudinally adjacent drive lug.

31. The endless track of claim 30, wherein the second direction is substantially opposite the first direction.

32. The endless track of claim 30, wherein the second direction is substantially the same as the first direction.

33. The endless track of claim 30, further comprising:
a connecting section that connects the first guiding brace and the second guiding brace.

34. The endless track of claim 33, wherein the connecting section is at least partially embedded in the endless track.

35. The endless track of claim 33, wherein the connecting section includes at least one aperture configured to interact with a portion of the endless track.

36. The endless track of claim 33, wherein the connecting section is thicker in a region between the at least one of the drive lugs and the transversely adjacent drive lug.

37. The endless track of claim 33, further comprising:
a rib protruding from the connecting section in a direction away from the drive lugs.

38. The endless track of claim 37, wherein the rib spans at least a region of the connecting section between the at least one of the drive lugs and the transversely adjacent drive lug.

39. The endless track of claim 1, further comprising:
a plurality of longitudinal belts embedded in the endless track.

40. The endless track of claim 39, wherein a longitudinal belt embedded in the endless track in a vicinity of the drive lugs is of a greater dimension than a longitudinal belt embedded in the endless track between transversely adjacent drive lugs.

41. The endless track of claim 39, wherein a longitudinal belt embedded in the endless track in a vicinity of the drive lugs is of a greater dimension than a longitudinal belt embedded in the endless track outside of the drive lugs.

42. The endless track of claim 39, wherein a body of the endless track is made of a first polymeric material and the longitudinal belts are made of a second polymeric material that is different than the first polymeric material.

43. The endless track of claim 42, wherein the longitudinal belts are made of kevlar.

44. The endless track of claim 1, further comprising:
an exterior surface facing a direction opposite the interior surface, wherein the exterior surface includes a portion of a tread with a cutout.

45. The endless track of claim 1, comprising at least one section interconnected by at least one master link joint assembly.

46. An endless drive track system for use with a tracked vehicle, comprising:
a drive system;
an endless drive track having a plurality of drive lugs, each drive lug including an inside longitudinal face, an outside longitudinal face and at least one drive face that cooperates with the drive system; and
a guiding brace adjacent at least one of the inside and outside longitudinal faces of at least one of the drive lugs, the guiding brace extending beyond the at least one of the inside and outside longitudinal faces of the at least one of the drive lugs in a direction toward a longitudinally adjacent drive lug.

47. The endless drive track system of claim 46, further comprising:
a plurality of roller wheels that guide and support the endless drive track, the guiding brace cooperating with the plurality of roller wheels to guide the endless drive track by reducing undesired lateral movement of the endless drive track relative to the roller wheels.

48. The endless drive track system of claim 46, further comprising:
a plurality of roller wheels that guide and support the endless drive track, wherein the guiding brace protects at least a portion of the at least one of the inside and outside longitudinal faces of the at least one of the drive lugs from contact with the roller wheels.

49. A method for making an endless track having a plurality of drive lugs, each drive lug having first and second longitudinal faces, the endless drive track including an interior surface from which each drive lug of the plurality of drive lugs extends, the method comprising:
forming the endless track; and
providing a guiding brace adjacent at least one of the first and second longitudinal faces of at least one of the drive lugs such that the guiding brace extends beyond the at least one of the first and second longitudinal faces of the at least one of the drive lugs in a direction toward a longitudinally adjacent drive lug.
